(19) United States
(12) Patent Application Publication
(10) Pub. No.: US 2015/0340031 A1
(43) Pub. Date: Nov. 26, 2015

(54) TERMINAL AND CONTROL METHOD THEREFOR

(71) Applicant: LG ELECTRONICS INC., Seoul (KR)

(72) Inventors: Juhee KIM, Seoul (KR); Jungkyu CHOI, Seoul (KR); Jonghwan KIM, Seoul (KR); ChoongNyoung SEON, Seoul (KR); Joonyup LEE, Seoul (KR)

(73) Assignee: LG ELECTRONICS INC., Seoul (KR)

(21) Appl. No.: 14/759,828

(22) PCT Filed: Jan. 9, 2013
(86) PCT No.: PCT/KR2013/000190

§ 371 Date: Jul. 8, 2015

(51) Int. Cl. G10L 15/08; G10L 17/22

(52) U.S. Cl. CPC G10L 15/08; G10L 17/22

(57) ABSTRACT

A method for controlling the operation of a terminal according to an embodiment of the present invention includes the steps of: operating the terminal in a voice-recognition mode by receiving a voice-recognition command from the user; analyzing a voice received from the user so as to determine the user's intention; outputting the primary response in a voice according to the user's intention; analyzing the user's reaction to the primary response; and controlling the operation of the terminal according to the result of analyzing the user's reaction.

### TECHNICAL FIELD

The present disclosure relates to a terminal and control method therefor.

### BACKGROUND ART

As functions of terminals [internet network VS base station] such as personal computers, notebooks, or mobile phones are diversified, the terminals are implemented in a type of multimedia player equipped with composite functions such as capturing a photo or video, playback of music or video files, playing game, and broadcast reception.

According to whether to be portable, terminals may be divided into mobile terminals and stationary terminals. According to whether to be directly portable by a user, the mobile terminals may be divided again into handheld terminals and vehicle mount terminals.

In order to support and increase functions of the terminal, improving a structural part and/or software part of the terminal may be considered.

Recently, efforts are continued for providing a user interface enabling a user to more conveniently control an operation of a terminal by applying a voice recognition technique to the mobile terminal.

A response to a user' utterance is generated through a process for performing voice recognition for the user's utterance and processing a natural language for the voice recognition result.

However, a typical response generation method for the user' utterance has limitations in that since a terminal itself may not know whether the response is proper to the user's utterance after the response generation, when the user determines that the response of the terminal is not proper, the user has to express his/her intention in a method of giving a secondary utterance of no or manually operating the terminal to cancel the response.

### DISCLOSURE OF THE INVENTION

### Technical Problem

Embodiments provide a terminal and control method therefor capable of analyzing a user's response and outputting a secondary response according to the analyzed result to reduce a secondary action of the user and to improve user's convenience, when a primary response output according to recognition of user's voice does not match user's intention.

### Technical Solution

In one embodiment, a control method for a terminal includes: receiving, by the terminal, a voice recognition command from a user to operate in a voice recognition mode; receiving a voice of the user to analyze a user's intention; outputting in a voice a primary response according to the analyzed user's intention; analyzing a user's response according to the output primary response; and controlling an operation of the terminal according to the analyzed user's response.

In another embodiment, a control method for a terminal includes: receiving, by the terminal, a voice recognition command from a user to operate in a voice recognition mode; receiving a voice of the user to analyze a user's intention; generating response lists according to the analyzed user's intention; outputting a primary response having a first priority among the generated response lists; analyzing a user's response according to the output primary response; and controlling an operation of the terminal according to the analyzed user's response.

### Advantageous Effects

According to embodiments, when a primary response output according to recognition of user's voice does not match user's intention, a user's response is analyzed and a secondary response is output according to the analyzed result, and accordingly a secondary action of the user can be reduced and user's convenience can be improved.

### BRIEF DESCRIPTION OF THE DRAWINGS

FIG. 1 is a block diagram of a mobile terminal according to an embodiment.

FIG. 2 is a block diagram illustrating an additional element of a mobile terminal according to an embodiment.

FIG. 3 is a view for explaining a process for extracting a user's expression according to an embodiment.

FIG. 4 is a flowchart illustrating an operation method of a terminal according to another embodiment.

### MODE FOR CARRYING OUT THE INVENTION

Hereinafter, a mobile terminal related to an embodiment will be described in detail with reference to drawings. In the following description, usage of suffixes such as ‘module’, ‘part’ or ‘unit’ used for referring to elements is given merely to facilitate explanation of an embodiment, without having any significant meaning by itself.

A mobile terminal described herein may include a mobile phone, smartphone, laptop computer, digital broadcast terminal, personal digital assistant, portable multimedia player, and navigator. However, those skilled in the art may easily understand that a configuration according to an embodiment is also applicable to a stationary terminal such as a digital TV or desktop computer, except for a case where the configuration is only applicable to a mobile terminal.

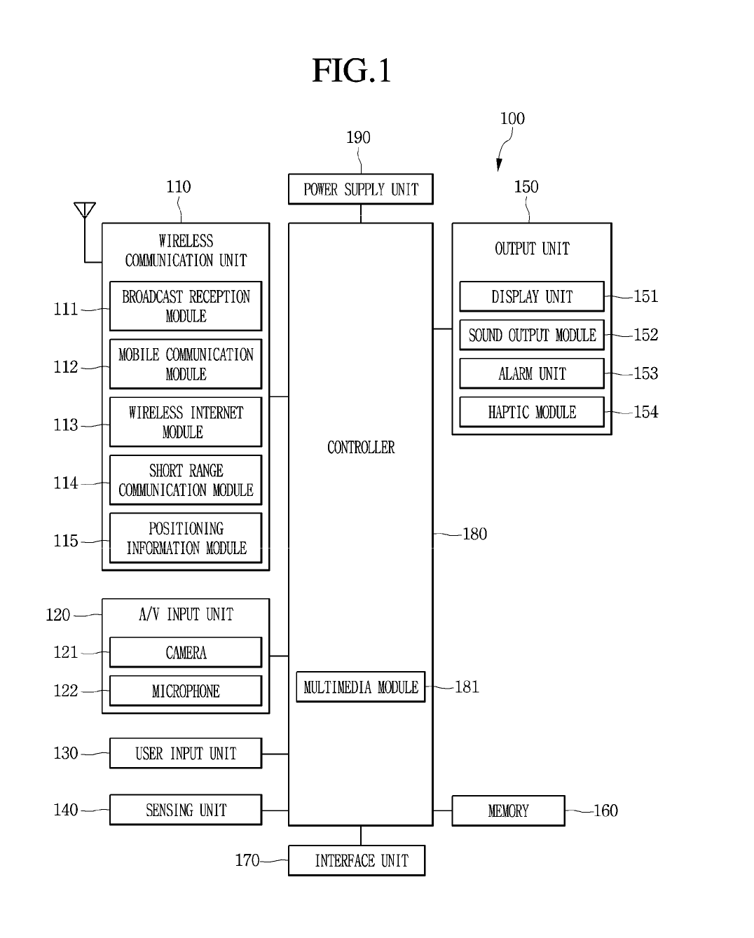

Hereinafter a description is provided about a structure of a mobile terminal according to an embodiment with reference to FIG. 1.

FIG. 1 is a block diagram of a mobile terminal according to an embodiment.

A mobile terminal 100 may include a wireless communication unit 110, an audio/video (A/V) input unit 120, a user input unit 130, a sensing unit 140, an output unit 150, a memory 160, an interface unit 170, a controller 170, and a power supply unit 190. Since the elements illustrated in FIG. 1 are not essential, a mobile terminal including more or less than those may be implemented.

Hereinafter, the elements will be sequentially described.

The wireless communication unit 110 may include one or more modules enabling wireless communication between the mobile terminal 100 and a wireless communication system or between the mobile terminal 100 and a network in which the mobile terminal 100 is located. For example, the wireless communication unit 110 may include a broadcast reception module 111, a mobile communication module 112, a wireless internet module 113, a short range communication module 114, and a positioning module 115.

The broadcast reception module 111 receive a broadcast signal and/or broadcast related information from an external broadcast managing server through a broadcast channel.

The broadcast channel may include a satellite channel or terrestrial channel. The broadcast managing server may mean a server generating to transmit the broadcast signal and/or broadcast related information or a server receiving a pre-generated broadcast signal and/or broadcast related information to transmit them/it to a terminal. The broadcast signal may include not only a TV broadcast signal, radio broadcast signal, and data broadcast signal, but also a broadcast signal in a type that the data broadcast signal is combined to the TV broadcast signal or radio broadcast signal.

The broadcast related information may mean information related to a broadcast channel, broadcast program, or broadcast service provider. The broadcast related information may be provided through a mobile communication network. In this case, reception is performed by the mobile communication module 112.

The broadcast related information may be provided in various types. For example, it may be present in a type of Electronic Program Guide (EPG) of Digital Multimedia Broadcasting (DMB) or Electronic Service Guide (ESG) of Digital Video Broadcast-Handheld (DVB-H).

The broadcast reception module 111 may receive a digital broadcast signal by using a digital broadcast system, for example, Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), or Integrated Services Digital Broadcast-Terrestrial (ISDB-T). The broadcast reception module 111 may be configured to be suitable not only for the aforementioned digital broadcast system but also for another broadcast system.

The broadcast signal and/or broadcast related information received through the broadcast reception module 111 may be stored in the memory 160.

The mobile communication module 112 transmits and receives a wireless signal to and from at least one of a base station, external terminal, and server on a mobile communication network. The wireless signal may include data in various types according to transmission and reception of a voice call signal, video call signal, or character/multimedia message.

The wireless internet module 113 refers to a module for a wireless internet access and may be mounted internally or externally to the mobile terminal 100. For example, for the wireless internet access, wireless LAN (WLAN), Wi-Fi, Wireless broadband (WiBro), World Interoperability for Microwave Access (Wimax), or High Speed Downlink Packet Access (HSPA) may be used.

The short range communication module 114 refers to a module for short range communication, and Bluetooth, radio frequency Identification (RFID), infrared data association (IrDA), ultra wideband (UWB), or ZigBee may be used as the short range communication technique.

The positioning module 115 is a module for obtaining a position of the mobile terminal, and as a representative example thereof, there is a global positioning system (GPS) module.

Referring to FIG. 1, the A/V input unit 120 is for an input of an audio signal or video signal, and may include a camera 121 and a microphone 122. The camera 121 processes an image frame such as a still image or video obtained by an image sensor in a video call mode or capturing mode. The processed image frame may be displayed on a display unit 151.

The image frame processed in the camera 121 may be stored in the memory 160 or transmitted externally through the wireless communication unit 110. According to a use environment, two or more cameras 121 may be provided.

The microphone 122 receives an external sound signal with a microphone in such as a call mode, recording mode, or voice recognition mode and processes the sound signal to electrical voice data. In the call mode, the processed voice data may be converted into a type transmittable to a mobile communication base station through the mobile communication module 112 to be output. Various noise removing algorithms may be implemented for removing noise occurring in a process for receiving the external sound signal.

Through the user input unit 130, the user generates input data for an operation control of the terminal. The user input unit 130 may be configured with a key pad, dome switch, touch pad (static pressure/electrostatic), jog wheel, jog switch, and the like.

The sensing unit 140 senses a current state of the mobile terminal 100 such as an open or closed state of the mobile terminal 100, a position of the mobile terminal 100, whether the user contacts, orientation of the mobile terminal, acceleration/deceleration of the mobile terminal 100 to generate a sensing signal for controlling an operation of the mobile terminal 100. For example, a case where the mobile terminal 100 is in a slide phone type, an open or closed state of the slide phone may be sensed. In addition, whether power is supplied from the power supply unit 190, or whether the interface unit 170 is combined to an external device may also be sensed. Furthermore, the sensing unit 140 may include a proximity sensor 141.

The output unit 150 is for generating an output related to sight, hearing, or touch, and may include the display unit 151, a sound output module 152, an alarm unit 153, a haptic module 154, and the like.

The display unit 151 displays (outputs) information processed by the mobile terminal 100. For example, when the mobile terminal is in a call mode, a user interface (UI) or graphic user interface (GUI) related to a call is displayed. When the mobile terminal 100 is in a video call mode or capturing mode, a captured or/and received image or UI or GUI is displayed.

The display unit 151 may include at least one of a liquid crystal display (LCD), thin film transistor-liquid crystal display (TFT LCD), organic light emitting diode (OLED), flexible display, and 3D display.

Some of the displays may be formed in a transparent or transmissive type capable of viewing the outside therethrough. This may be called a transparent display, and a representative example thereof is a transparent OLED or the like. A rear side structure of the display unit 151 may be formed in a light transmissive structure. According to such a structure, the user may see an object positioned at the rear side of a terminal body through an area occupied by the display unit 151 of the terminal body.

According to an implementation type of the mobile terminal 100, there may be two or more display units 151. For example, a plurality of display units are disposed separated or integrated on one surface or respectively disposed on surfaces different from each other in the mobile terminal 100.

When the display unit 151 and a sensor sensing a touch operation (hereinafter, ‘touch sensor’) are formed a mutual layer structure (hereinafter, ‘touch screen’), the display unit 151 may be used as an input unit other than an output unit. The touch sensor may have, for example, a touch film, touch sheet, touch pad, or the like.

The touch sensor may be configured to convert a change in pressure applied on a specific portion of the display unit 151 or electrostatic capacity generated in a specific portion of the display unit 151 into an electrical input signal. The touch sensor may be configured to detect not only a touched position and area but also pressure at the time of touch.

When there is a touch input for the touch sensor, a signal (signals) corresponding thereto is (are) transmitted to a touch controller. The touch controller processes the signal(s) and then transmits data corresponding thereto to the controller 180. Accordingly, the controller 180 may know which area of the display unit 151 is touched.

Referring to FIG. 1, the proximity sensor 141 may be disposed in an internal area enclosed by the touch screen of the mobile terminal or around the touch screen. The proximity sensor 141 refers to a sensor detecting presence or not of an object approaching or in the proximity of a predetermined detecting surface by using an electromagnetic field force or an infrared ray without a mechanical contact. The proximity sensor 141 has a longer life and higher availability than a contact sensor.

An example of the proximity sensor 141, there are a transmissive photoelectric sensor, directly reflective photoelectric sensor, a high frequency oscillatory proximity sensor, electrostatic proximity sensor, magnetic proximity sensor, infrared proximity sensor, and the like. When the touch screen is electrostatic, approach of a pointer is detected by a change in electric field according to proximity of the pointer. In this case, the touch screen (touch sensor) may be classified to a proximity sensor.

Hereinafter for convenience of explanation, an action is called “proximity touch” that a pointer does not contact the touch screen but is recognized as positioned on the touch screen, and an action is called “contact touch” that the pointer actually contacts the touch screen. A position at which the pointer touches in proximity on the touch screen means a position that the pointer vertically corresponds to the touch screen when the pointer touches in the proximity on the touch screen.

The proximity sensor senses a proximity touch and a proximity touch pattern (e.g., proximity distance, proximity touch direction, proximity touch speed, proximity touch time, proximity touch position, proximity movement state, and the like). Information corresponding to the sensed proximity touch action and proximity touch pattern may be output on the touch screen.

The sound output module 152 may be received from the wireless communication unit 110 in a call signal reception mode, call mode or recording mode, voice recognition mode, broadcast reception mode or the like, or output audio data stored in the memory 160. The sound output module 152 also outputs a sound signal relating to a function (e.g., call signal reception sound, message reception sound, or the like) performed by the mobile terminal 100. The sound output module 152 may include a receiver, speaker, or buzzer.

The alarm unit 153 outputs a signal for notifying an event occurrence of the mobile terminal 100. As an example of an event occurring in the mobile terminal, there are a call reception signal, message reception, key signal input, touch input, and the like. The alarm unit 153 may also output a signal for notifying an event occurrence in another type, for example, vibration, other than a video signal or audio signal. The video signal or audio signal may be output through the display unit 151 or the voice output module 152, which may be classified to a part of the alarm unit 153.

The haptic module 154 generates various tactile effects that the user may sense. A representative example of the tactile effect generated by the haptic module 154 may be vibration. The intensity and pattern generated by the haptic module 154 are controllable. For example, different vibrations may be output in a synthesized type or in a sequential type.

The haptic module 154 may generate various tactile effects such as an effect by an arrangement of pins vertically moving with respect to a contact skin surface, an air jetting force or air absorptive force through an air jetting opening or air absorptive opening, brushing against skin surface, contact to an electrode, or a stimulus such an electrostatic force, and an effect due to reproduction of the sensor of heat or coolness by using an element capable of absorbing or generating heat.

The haptic module 154 may be realized so that the user senses the tactile effect through muscle sense of a finger or arm, as well as delivering a tactile effect through a direct contact. The haptic modules 154 may be provided two or more in number according to a configuration aspect of the mobile terminal 100.

The memory 160 may store programs for an operation of controller 180 and temporarily store input/output data (e.g., phonebook message, still image, video or the like). The memory 160 may store data about various patterned vibrations and data about sound output at the time of touch input on the touch screen.

The memory 160 may include at least one type of recording medium such as an SD or XD memory, a flash memory type, hard disk type, multimedia card micro type, and card type memory, read only memory (ROM), static random access memory (SRAM), random access memory (ROM), electrically erasable programmable read-only memory (EEPROM), or programmable read only memory (PROM). The mobile terminal 100 may operate in relation to a web storage performing a storage function of the memory 160 on the internet.

The interface unit 170 plays a role as a channel with all external devices connected to the mobile terminal 100. The interface unit 170 receives data from an external device, or power to deliver it to each element inside the mobile terminal 100 or allows internal data of the mobile terminal 100 to be transmitted to the external devices. For example, the interface unit 170 may include a wired/wireless headset port, external charger port, wired/wireless data port, and memory card port, a port for connecting a device to which an identification module is provided, a video input/output (I/O) port, a earphone port, or the like.

The identification module is a chip storing various pieces of information for authenticating use authority, and may include a user identify module (UIM), subscriber identity module (SIM), universal subscriber identity module (USIM), or the like. A device (hereinafter ‘identification device’) including an identification module may be manufactured in a smart card type. Accordingly, the identification device may be connected to the terminal 100 through a port.

The interface unit may be a channel through which power from an external cradle is supplied to the mobile terminal 100 when the mobile terminal 100 is connected to the cradle or a channel through which various types of command signals input from the cradle by the user are delivered to the mobile terminal 100. The various types of command signals or the power input from the cradle may be operated as signals for perceiving that the mobile terminal is accurately mounted in the cradle.

The controller 180 normally controls an overall operation of the mobile terminal. For example, the controller performs a control or a process related to a voice call, data communication, video call or the like. The controller 180 may include a multimedia module 181 for playing multimedia. The multimedia module 181 may be implemented inside the controller 180 or separately implemented from the controller 180.

The controller 180 may perform a pattern recognition process through which a written input or drawing input performed on the touch screen may be recognized as a character or image.

The controller 180 may analyze a user's intention about which operation the user performs with the user terminal 100 through the received user's voice.

The controller 180 may generate a response list according to the analyzed user's intention.

The controller 180 may output a primary response to the user's intention in a voice, and then automatically activate an operation of the camera 121 to capture the user.

The controller 180 may activate an operation of the camera 121 at the same time when the primary response among the generated response lists is output through the display unit 151.

The controller 180 may analyze a user's response through the captured user image.

The controller 180 may determine whether the user's response is positive or negative according to the analyzed result of user's response. When the user's response is checked as positive, the controller 180 may control the mobile terminal 100 to perform an operation corresponding to the primary response output by the sound output module 152. Furthermore, when the user's response is checked as negative, the controller 180 may output a secondary response corresponding to the negative response through the sound output module 152.

The controller 180 may analyze an image for an utterance environment around the user captured through the camera 121 to output a response according to the analyzed result. For example, when the image for the utterance environment around the user is entirely dark, it is determined the utterance environment around the user as a dark and late night to output a voice of “recommend music nice to listen before sleep” together with a recommendation music list through the display unit 151.

The power supplying unit 190 receives external and internal power under a control of the central controller 180 and supplies power necessary for operating each element.

Various embodiments described herein may be implemented on a recording media readable with a computer or similar device by using, for example, software, hardware, or a combination thereof.

According to hardware implementation, embodiments described herein may be implemented by using at least any one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, or electric units for performing other functions. In some cases, such embodiments may be realized by the controller 180.

According to software implementation, embodiments such as procedures or functions, may be implemented together with separate software modules enabling at least functions and operations to be performed. A software code may be implemented by a software application written in a proper program language. The software code may be stored in the memory 160 and performed by the controller 180.

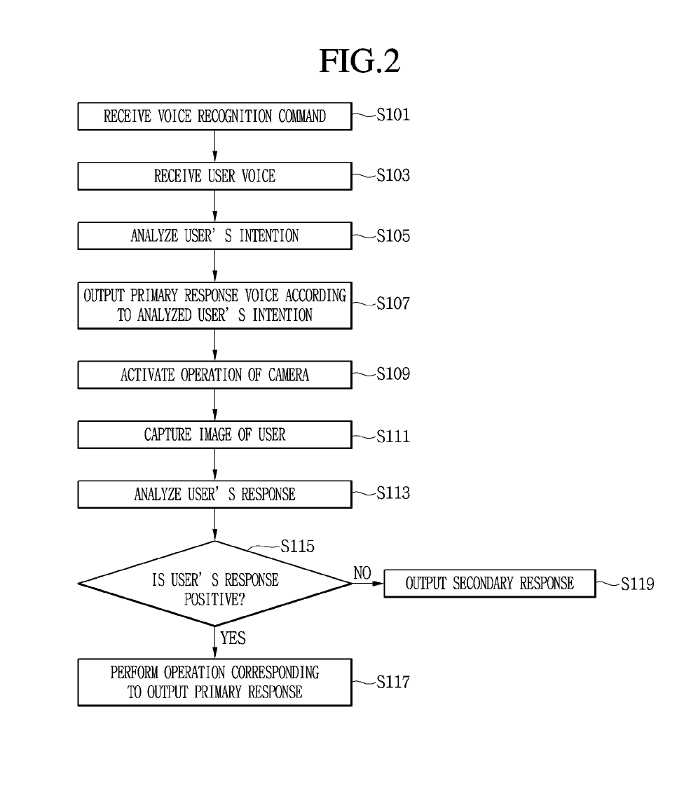

FIG. 2 is a flowchart illustrating an operation method of a stretchable display device according to an embodiment.

The controller 180 receives a voice recognition command for activating an operation mode of the mobile terminal 100 in a voice recognition mode through the user input (operation S101). The operation mode of the terminal 100 may be set as a call mode, capturing mode, recording mode, voice recognition mode, or the like, and when the user inputs the voice recognition command through the user input unit 130, the controller 180 may receive the voice recognition command to activate the operation mode of the mobile terminal 100 in the voice recognition mode. In an embodiment, when a voice input icon of a microphone shape displayed on the display unit 151 of the mobile terminal 100 is selected by the user input, the controller 180 activates the operation mode of the mobile terminal in the voice recognition mode.

The microphone 122 of the A/V input unit 120 may receive a voice uttered by the user in a voice recognition mode change according to the received voice recognition command (operation S103). The microphone 122 may receive a sound signal from the user and process it to electrical voice data. Noise generated in a process where the microphone 122 receives various external sound signals may be removed with various noise removal algorithms.

The controller 180 may analyze through the received user's voice a user's intention about which operation the user performs with the mobile terminal 100 (operation S105). For example, when the user speaks “call Yeong-hae Oh” to the microphone 122, the controller 180 confirms that the user is going to activate the operation mode of the mobile terminal 100 in a call mode to analyze the user's intention. Here, the operation mode of the terminal 100 may be maintained as the voice recognition mode.

The sound output module 152 outputs a primary response according to the analyzed user's intention in a voice (operation S107). For example, the sound output module 152 may output in a voice the primary response “I will make a call to Yeong-hae Oh” as a response to the user's utterance of “call Yeong-hae Oh”.

In an embodiment, the sound output module 152 may be a speaker mounted in one side of the mobile terminal 100.

After the primary response according to the user's intention in a voice, the controller 180 activate an operation of the camera 121 for capturing a user's response to the primary response output in a voice. In other words, after the primary response to the user's intention is output in a voice, the controller 180 may automatically activate an operation of the camera 121 for capturing the user. Activating the operation of the camera 121 may mean that an operation of the camera 121 is turned on and a user's image is captured through a preview screen of the display unit 151.

In an embodiment, the camera 121 may include front and rear side cameras. The front side camera may be mounted on the front side of the mobile terminal 100 to capture an image frame of a still image or a video obtained in a capturing mode of the mobile terminal 100, and the captured image frame may be displayed through the display unit 151. The rear side camera may be mounted on the rear side of the mobile terminal 100.

In an embodiment, the camera 121 of which an operation is activated may be front side camera, but is not limited hereto.

The operation-activated camera 121 captures the user's image (operation S111). In other words, the camera 121 may capture a response image of the user with respect to the primary response output in a voice. In an embodiment, the user's response may mean an expression of the user's face or a user's gesture.

The controller 180 may analyze a user's response through the captured user image (operation S113). In an embodiment, the controller 180 may compare a pre-stored user's image with a captured user's image to analyze the user' response. In detail, the user's response may include a positive response representing a case where the output response matches the user's intention and a negative response representing a case where the output response does not match the user's intention, and the memory 160 may pre-store a plurality of images corresponding to the user's positive response and a plurality of images corresponding to the user's negative response. The controller 180 may compare the captured user's image with the user's image pre-stored in the memory 160 to analyze the user' response.

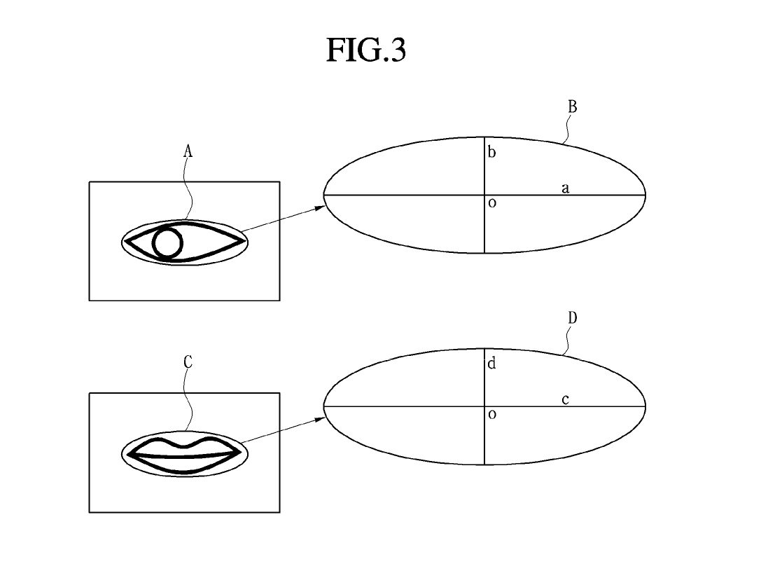

In another embodiment, the controller 180 may extract expression on the user's face displayed on the preview screen of the display unit 151 to analyze the user's response. In an embodiment, the controller 180 may extract contours (i.e., edges) with respect to the eye and mouth regions of the user, which is displayed on the preview screen, and extract the user's expression. In detail, the controller 180 may extract a closed curve through the edges of the extracted eye and mouth regions and detect the user's expression by using the extracted closed curve. In more detail, the extracted closed curve may be an ellipse and when the closed curve is assumed to be an ellipse, the controller 180 may detect the user's expression by using base points, and lengths of the major axis and minor axis of the ellipse. Regarding this, detailed description is provided with reference to FIG. 3.

FIG. 3 is a view for explaining a process for extracting a user's expression according to an embodiment.

FIG. 3 illustrates a contour A of the eye region the user, a first closed curve B for the contour of the eye region, a contour C of the mouth region of the user, and a second closed curve D for the contour of the mouth region. Typically, since the user's expression may be represented with the eyes and mouth, in an embodiment, it is assumed that the user's expression is extracted by using the contours of the eye and mouth regions of the user and the first and second closed curves B and D are ellipses.

The major and minor axis lengths of the first closed curve B are respectively a and b, and the major and minor axis lengths of the second closed curve D are respectively c and d. The major and minor axis lengths of the first and second close curves B and D may vary according to the user's expression. For example, in a case where the user smiles, typically the major axis lengths a and c of the first and second closed curves B and D may be lengthened, and minor axis lengths b and d of the first and second closed curves B and D may be shortened.

The controller 180 may compare a relative ratio of the major length to minor length of each closed curve to extract the user' expression. In other words, the controller 180 may compare the relative ratio of the major length to minor length of each closed curve to check how much the user′ eyes are open, or how much the user's mouth is open, and then to extract the user's expression through the checked result.

In an embodiment, when the first closed curve for the user's eye region is an ellipse and a ratio of the major axis length to the minor axis length of the ellipse is equal to or greater than a preset ratio, the user's response may be set as a positive response and otherwise, may be set as a negative response.

In an embodiment, the controller 180 may extract the user's expression by using the extracted eye region of the first closed curve and the extracted mouth region of the second closed curve, but the extraction is not limited hereto. In addition, the user's expression may also be extracted by using only the eye region of the first closed curve or only the mouth region of the second closed curve.

A description will be provided with reference to FIG. 2 again.

The controller 180 may determine whether the user's response is positive or negative according to the analyzed result of user's response (operation S115).

When the user's response is checked as positive, the controller 180 may control the mobile terminal 100 to perform an operation corresponding to the primary response output by the sound output module 152 (operation S117). For example, when the primary response output according to the user's intention from the sound output module 152 is “I will make a call to Yeong-hae Oh” and the user's response thereto is positive in operation S107, the controller 180 operates the operation mode of the mobile terminal 100 in a call mode and transmits a call signal to a terminal of Yeong-hae Oh through the wireless communication unit 110.

Furthermore, when the user's response is checked as negative, the controller 180 may output the secondary response corresponding to the negative response through the sound output module 152 (operation S119).

The secondary response may include a candidate response and an additional input lead response.

In an embodiment, it may mean a candidate response matching best to the analyzed user's intention. For example, when the primary response output according to the user's intention from the sound output module 152 is “I will make a call to Yeong-hae Oh” and the user's response thereto is negative in operation S107, the controller 180 may control he sound output module 152 to output a response to “I will make a call to Yeong-hae Oh”, which is a secondary response.

In an embodiment, when it is confirmed that the user′ response is negative, the controller 180 may output the additional input lead response instead of the candidate response through the sound output module 152. For example, when the primary response output according to the user's intention from the sound output module 152 is “I will make a call to Yeong-hae Oh” and the user's response thereto is negative in operation S107, the controller 180 may control the sound output module 152 to output a secondary response to “re-speak the name”, which is the additional input lead response.

Like this, according to embodiments, when a primary response output according to recognition of user's voice does not match user's intention, the user's response may be analyzed and a secondary response may be output according to the analyzed result, and accordingly a secondary action of the user may be reduced and user's convenience may be improved.

Next, a description will be provided about an operation method of a mobile terminal according to another embodiment.

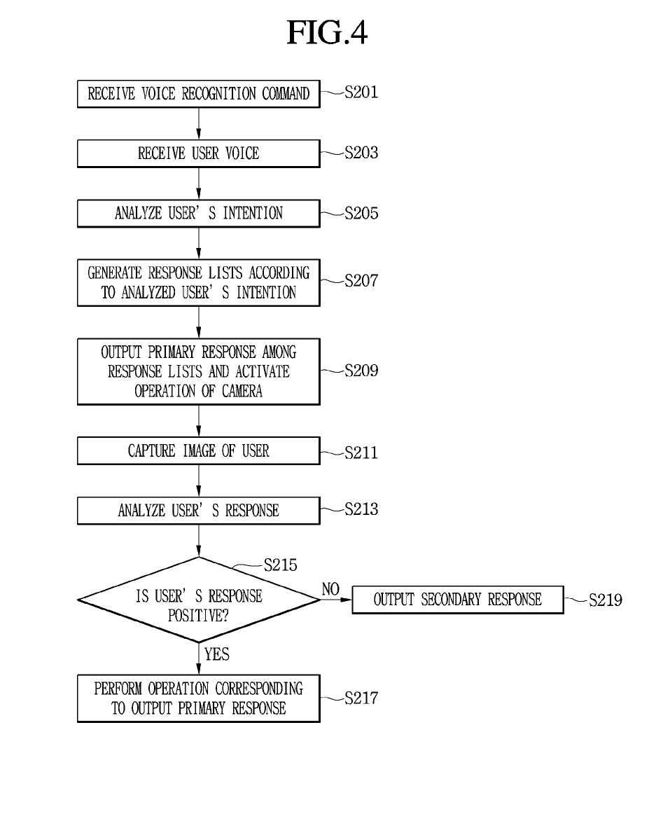

FIG. 4 is a flowchart illustrating a control method for a terminal according to another embodiment.

The controller 180 receives a voice recognition command for activating an operation mode of the terminal 100 in a voice recognition mode through the user input (operation S201).

The microphone 122 of the A/V input unit 120 may receive a voice uttered by the user in a voice recognition mode converted according to the received voice recognition command (operation S103).

The controller 180 may analyze a user's intention about which operation the user performs with the mobile terminal 100 through the received user's voice received (operation S205). For example, when the user speaks “search for Jeonju (name of a city)” to the microphone 122, the controller 180 checks whether the user is to activate the operation mode of the mobile terminal 100 in a search mode to analyze the user's intention. Here, the operation mode of the terminal 100 may be maintained as the voice recognition mode. Here, the search mode may mean a mode in which the mobile terminal 100 accesses a search site on the internet and searches a word input through the microphone 122.

The controller 180 may generate a response list according to the analyzed user's intention (operation S207). In an embodiment, the response list may be a list including a plurality of responses matching best with the user's intention. For example, when the user speaks “search Jeonju” to the microphone 122 and the operation mode of the terminal 100 is set as the search mode, the response list may be a list including a plurality of search results corresponding to the word “Jeonju”. Here, the plurality of search results may include search results of “Jeonju”, search results of “Jinju”, and search results of “Jeonjo”.

In an embodiment, a priority in the response lists may be determined according to an output order. In other words, the priority in the response lists may be determined according to an order of matching best to the user's intention.

The controller 180 may activate an operation of the camera 121 at the same time when the primary response among the generated response list is output through the display unit 151 (operation S209). In an embodiment, the primary response may be a response having a first priority matching best to the user's intention.

For example, when the user speaks “search Jeonju” to the microphone 122, the controller 180 may set the search results for “Jeonju” as the first priority in the response lists to output the primary response being the search results for “Jeonju”. The controller 180 may activate a camera operation for capturing a user's response to the primary response at the same time when outputting the primary response.

The operation-activated camera 121 captures the user's image (operation S211). In other words, the camera 121 may capture a response image of the user with respect to the primary response output on the display unit 151.

The controller 180 may analyze a user's response through the captured user's image (operation S213). A detailed description thereabout is the same as that described with response to FIG. 2.

The controller 180 may determine whether the user's response is positive or negative according to the analyzed result of user's response (operation S215).

When the user's response is checked as positive, the controller 180 may control the mobile terminal 100 to perform an operation corresponding to the output primary response (operation S217). For example, when the primary response output on the display unit 151 according to the user's intention is the search results for “Jeonju” and the user's response thereto is positive in operation S209, the operation of the mobile terminal 100 is maintained without a change and the mobile terminal 100 waits for a user's input.

Furthermore, when the user's response is checked as negative, the controller 180 may output the secondary response corresponding to the negative response (operation S219).

For example, when the primary response output on the display unit 151 according to the user's intention is the search results for “Jeonju” and the user's response thereto is negative in operation S209, the operation of the mobile terminal 180 may output the secondary response to the display unit 151.

In an embodiment, the secondary response may be a response to the search results having a second priority among the response lists that the priorities thereof are determined. For example, when the search result having the second priority is for “Jenoju”, the secondary response may be the search result for “Jeonju”.

In another embodiment, the secondary response may be the response list itself that the priorities thereof are determined.

According to an embodiment, the above-described method may be implemented as a processor-readable code on a medium with a program recorded thereon. Examples of the computer readable recording medium include a hard disk, read-only memory (ROM), random-access memory (RAM), CD-ROMs, magnetic tapes, floppy disks, and optical data storage devices, and carrier waves (such as data transmission through the Internet).

As can be seen from the foregoing, the mobile terminal in accordance with the above-described embodiments is not limited to the configurations and methods of the embodiments described above, but the entirety of or a part of the embodiments may be configured to be selectively combined such that various modifications of the embodiments can be implemented.

1. A control method for a terminal, the control method comprising:
receiving, by the terminal, a voice recognition command from a user to operate in a voice recognition mode;
receiving a voice of the user to analyze a user's intention;
outputting in a voice a primary response according to the analyzed user's intention;
analyzing a user's response according to the output primary response; and
controlling an operation of the terminal according to the analyzed user's response.

2. The control method according to claim 1, further comprising activating a camera mounted on the terminal after the outputting of the primary response in a voice,
wherein the analyzing of the user's response comprises analyzing the user's response on the basis of a user's image captured through the activated camera.

3. The control method according to claim 2, wherein the analyzing of the user's response on the basis of the captured user' image comprises:
extracting user's expression on the basis of the captured user's image; and
analyzing the user's response on the basis of the extracted user's expression.

4. The control method according to claim 3, wherein when the user's response is analyzed to be positive, the controlling of the operation of the terminal comprises
controlling the operation of the terminal to perform an operation corresponding to the primary response.

5. The control method according to claim 3, further comprising outputting a secondary response corresponding to a negative response when the user's response is negative.

6. The control method according to claim 5, wherein the secondary response is a candidate response matching the analyzed user's intention.

7. The control method according to claim 5, wherein the secondary response is a candidate response close to a response matching the analyzed user's intention.

8. A control method for a terminal, the method comprising:
receiving, by the terminal, a voice recognition command from a user to operate in a voice recognition mode;
receiving a voice of the user to analyze a user's intention;
generating response lists according to the analyzed user's intention;
outputting a primary response having a first priority among the generated response lists;
analyzing a user's response according to the output primary response; and
controlling an operation of the terminal according to the analyzed user's response.

9. The control method according to claim 8, wherein the outputting of the primary response comprises activating a camera mounted on the terminal at the same time when the primary response is output in a voice, and
the analyzing of the user's response comprises analyzing the user's response on the basis of the user' image captured through the activated camera.

10. The control method according to claim 9, wherein the analyzing of the user' response on the basis of the captured user's image comprises:
extracting at least any one of user's expression and user's utterance environment on the basis of the captured user's image; and
analyzing the user's response on the basis of at least any one of the extracted user's expression and user's utterance environment.

11. A terminal comprising:
an output unit; and
a controller receiving a voice of a user, analyzing user's intention, outputting a primary response according to the analyzed user's intention in a voice through the output unit, analyzing a user's response according to the output primary response, and controlling an operation of the terminal according to the analyzed user's response.

12. The terminal according to claim 11, wherein the controller activates a camera mounted on the terminal and analyzes the user's response on the basis of the user's image captured through the activated camera, after the primary response is output in a voice.

13. The terminal according to claim 12, wherein the controller extracts user's expression on the basis of the captured user' image and analyzes the user's response on the basis of the extracted user's expression.

14. The terminal according to claim 13, wherein when the user's response is analyzed to be a positive response, the controller controls an operation of the terminal to perform an operation corresponding to the primary response.

15. The terminal according to claim 13, wherein when the user's response is analyzed to be a negative response, the controller outputs a secondary response corresponding to the negative response.

16. The terminal according to claim 15, wherein the secondary response is a candidate response matching the analyzed user's intention.

17. The terminal according to claim 15, wherein the secondary response is a candidate response close to a response matching the analyzed user's intention.

18. A terminal comprising:
an output unit; and
a controller receiving a voice of a user to analyze a user's intention, generating response lists according the analyzed user's intention, outputting a primary response having a first priority among the generated response lists, analyzing a user' response according to the output primary response, and controlling an operation of the terminal according to an operation for the analyzed user' response.

19. The terminal according to claim 18, wherein the controller activates a camera mounted on the terminal at the same time when the primary response is output in a voice, and analyzes the user's response on the basis of the user's image captured through the activated camera.

20. The terminal according to claim 19, wherein the controller extracts at least any one of user's expression and user's utterance environment on the basis of the captured user's image and analyzes the user's response on the basis of at least any one the of the extracted user' expression and utterance environment.
